(19) United States
(12) Patent Application Publication
(10) Pub. No.: US 2018/0052072 A1
(43) Pub. Date: Feb. 22, 2018

(54) GAS LEAK LOCATION ESTIMATING DEVICE, GAS LEAK LOCATION ESTIMATING SYSTEM, GAS LEAK LOCATION ESTIMATING METHOD AND GAS LEAK LOCATION ESTIMATING PROGRAM

(71) Applicant: KONICA MINOLTA, INC., Chiyoda-ku, Tokyo (JP)

(72) Inventor: Sei KOH, Hachioji-shi, Tokyo (JP)

(73) Assignee: KONICA MINOLTA, INC., Chiyoda-ku, Tokyo (JP)

(21) Appl. No.: 15/552,693

(22) PCT Filed: Mar. 7, 2016
(86) PCT No.: PCT/JP2016/057032

§ 371 Date: Aug. 22, 2017

(30) Foreign Application Priority Data
Mar. 9, 2015 (JP) 2015-045658

(51) Int. Cl. G01M 3/38; G01N 21/3518

(52) U.S. Cl. CPC G01M 3/38; G01N 21/3518

(57) ABSTRACT

A gas leak location estimating device includes: an information processor which acquires image information on a plurality of frames from an infrared camera, the information processor being capable of executing: a block discrimination processing of dividing an image area of each of the frames into a plurality of blocks and discriminating whether each of the blocks is a gas area; a count processing of counting a number of times each of the blocks is discriminated as the gas area, over the frames in chronological order, in the block discrimination processing; and a leak location estimation processing of setting, among the blocks, a block whose counted value obtained in the count processing is equal to or larger than a predetermined value as an estimated gas leak location.

### CROSS-REFERENCE TO RELATED APPLICATIONS

The present patent application is a U.S. National Phase application of International Application No. PCT/JP2016/057032, filed Mar. 7, 2016, which claims priority from Japanese Patent Application No. 2015-045658, filed Mar. 9, 2015, the entirety of which are incorporated herein by reference.

### TECHNOLOGICAL FIELD

The present invention relates to estimation of a gas leak location.

### DESCRIPTION OF THE RELATED ART

Heretofore, a system has been known to detect gas leaks in industrial plants with an infrared camera.

Patent Document 1 (Japanese Patent Application Laid-Open Publication No. Hei 09-021704) discloses a technique that involves selecting and displaying a pseudo color thermal image of an area having a temperature outside of a threshold based on an image signal acquired with the infrared camera to announce a gas leak and indicate the area having the temperature outside of the threshold due to the leaked gas.

Although the technique according to Patent Document 1 involves a process of displaying the area having the temperature outside of the threshold, it lacks the processing of analyzing and estimating the gas leak location and indicating and announcing the estimated gas leak location. Thus, users cannot accurately determine the gas leak location.

### SUMMARY

An object of the present invention, which has been conceived in light of the issues of the traditional art, is to accurately estimate a gas leak location.

To achieve at least one of the abovementioned objects, according to an aspect of the present invention, there is provided: a gas leak location estimating device including:

an information processor which acquires image information on a plurality of frames from an infrared camera, the information processor being capable of executing:
a block discrimination processing of dividing an image area of each of the frames into a plurality of blocks and discriminating whether each of the blocks is a gas area;
a count processing of counting a number of times each of the blocks is discriminated as the gas area, over the frames in chronological order, in the block discrimination processing; and
a leak location estimation processing of setting, among the blocks, a block whose counted value obtained in the count processing is equal to or larger than a predetermined value as an estimated gas leak location.

According to another aspect of the present invention, there is provided: a gas leak location estimating method acquiring image information on a plurality of frames from an infrared camera, the method including:

a block discrimination processing of dividing an image area of each of the frames into a plurality of blocks and discriminating whether each of the blocks is a gas area;

a count processing of counting a number of times each of the blocks is discriminated as the gas area, over the frames in chronological order, in the block discrimination processing; and

a leak location estimation processing of setting, among the blocks, a block whose counted value obtained in the count processing is equal to or larger than a predetermined value as an estimated gas leak location.

According to another aspect of the present invention, there is provided: a gas leak location estimating program causing a computer which acquires image information on a plurality of frames from an infrared camera, to execute:

a block discrimination processing of dividing an image area of each of the frames into a plurality of blocks and discriminating whether each of the blocks is a gas area;

a count processing of counting a number of times each of the blocks is discriminated as the gas area, over the frames in chronological order, in the block discrimination processing; and

a leak location estimation processing of setting, among the blocks, a block whose counted value obtained in the count processing is equal to or larger than a predetermined value as an estimated gas leak location.

### BRIEF DESCRIPTION OF THE DRAWINGS

The advantages and features provided by one or more embodiments of the invention can be fully understood from the detailed description given herein below. The appended drawings are not intended as a definition of the limits of the present invention.

FIG. 1 is a functional block diagram illustrating a gas leak location estimating system according to a first embodiment of the present invention.

FIG. 2 is a schematic diagram illustrating various processing carried out to image frames according to the first embodiment of the present invention.

FIG. 3 illustrates a first embodiment of the present invention and includes; schematic diagram Ga illustrating a result of a count processing carried out to an image frame and a block corresponding to the estimated gas leak location; schematic diagram Gb illustrating an example composite image for display.

FIG. 4 is a functional block diagram illustrating a gas leak location estimating system according to a second embodiment of the present invention.

FIG. 5 is a functional block diagram illustrating a gas leak location estimating system according to a third embodiment of the present invention.

FIG. 6 illustrates the third embodiment of the present invention and includes; schematic diagram Ga illustrating a result of a count processing carried out to an image frame, a block corresponding to the estimated gas leak location, and blocks as preset candidates of the gas leak location; and schematic diagram Gb illustrating an example composite image for display.

FIG. 7 is a schematic diagram illustrating various processing carried out to an image frame according to a fourth embodiment of the present invention.

FIG. 8 illustrates the fourth embodiment and includes; schematic diagram Ga illustrating a result of a count processing carried out to an image frame and a block corresponding to the estimated gas leak location; and schematic diagram Gb illustrating an example composite image for display.

### DETAILED DESCRIPTION OF EMBODIMENTS

Hereinafter, one or more embodiments of the present invention will be described with reference to the drawings. However, the scope of the invention is not limited to the disclosed embodiments.

A device of estimating a gas leak location, a system of estimating a gas leak location, a method of estimating a gas leak location, and a program of estimating a gas leak location according to embodiments of the present invention will now be described with reference to the accompanying drawings. The embodiments described below should not be construed to limit the present invention. The gas leak location estimating system described below includes a gas leak location estimating device carrying out a gas leak location estimating method on the basis of a gas leak location estimating program, and an infrared camera.

According to the present invention, the gas leak location can be accurately estimated by processing based on a plurality of frames in chronological order because a gas leak location becomes constant regardless of passage of time.

### First Embodiment

A gas leak location estimating system according to a first embodiment of the present invention will now be described.

The gas leak location estimating system 100 according to this embodiment includes an infrared camera 10, a visible light camera 20, and an information processor 30. The information processor 30 is composed of a computer including a processor and storage. A gas leak location estimating program stored in the storage is executed by the processor to activate functional components.

The information processor 30 includes the following functional components: a gas detector 31, a block divider 32, a block discriminator 33, a counter 34, a leak location estimator 35, and an image compositor 36.

The infrared camera 10 detects infrared radiant energy emerging from a monitoring target and converts the energy to a digital image signal. The visible light camera 20 detects visible light radiating from the monitoring target and converts the visible light to a digital image signal. The infrared camera 10 and the visible light camera 20 have identical angles of view. The monitoring target is, for example, a piping facility for an industrial plant.

The infrared camera 10 and the visible light camera 20 execute consecutive imaging at a predetermined frame rate (for example, 30 fps), and the frame data is sequentially input to the information processor 30.

The gas detector 31 detects a gas area in pixel unit from the infrared image signal input from the infrared camera 10 through any means, for example, temperature thresholding or motion detection method. The temperature thresholding is a method for discriminating a gas area, when a target to be detected is gas having a leakage temperature higher or lower than a temperature within a normal temperature range in the environment where the monitoring target is disposed, by using a threshold temperature for distinguishing from the temperature within the environment temperature range. The motion detection method is a method for discriminating a moving object area where differential signals of luminance signals of specific pixels in frames with respect to those of the respective pixels in a reference frame are higher than a predetermined threshold, to determine the moving object area as a gas area. The reference frame may be a one or more previous frame, or a past frame which has been still image as a whole in a certain period.

The block divider 32 divides each frame image of the infrared image signals into multiple blocks having a predetermined size. The size of a single block is, for example, 10×10 pixels.

The block discriminator 33 executes a block discrimination processing of discriminating whether each block in each frame is a gas area based on the results detected by the gas detector 31. The block discriminator 33 discriminates the block of which more than a predetermined percentage (50%, for example) of the pixels is detected as the gas area by the gas detector 31, and determines the block as the gas area. The block discriminator 33 assigns an identification value “1” to the block which is discriminated as the gas area, and an identification value “0” to the block which is not discriminated as the gas area.

The counter 34 executes a count processing of counting the number of times each block is discriminated as the gas area in the block discrimination processing, over chronological frames.

The leak location estimator 35 executes a leak location estimation processing of setting a block having a counted value which is obtained by the counter 34 and equal to or larger than a predetermined value, to an estimated gas leak location.

The image compositor 36 executes an image composition processing of defining a visible light image input from the visible light camera 20 as a back layer, extracting the pixels detected as the gas areas by the gas detector 31 from the infrared image signals input from the infrared camera 10, converting the extracted pixels to the visible light range to obtain an infrared imaging visualization image, overlaying the infrared imaging visualization image on the back layer while setting a predetermined transmittance, and overlaying an image indicating the block set as the estimated gas leak location by the leak location estimator 35 thereon. The composite image prepared by the image compositor 36 is output and displayed on the display monitor. A user can grasp the gas distribution and the gas leak location from the displayed image.

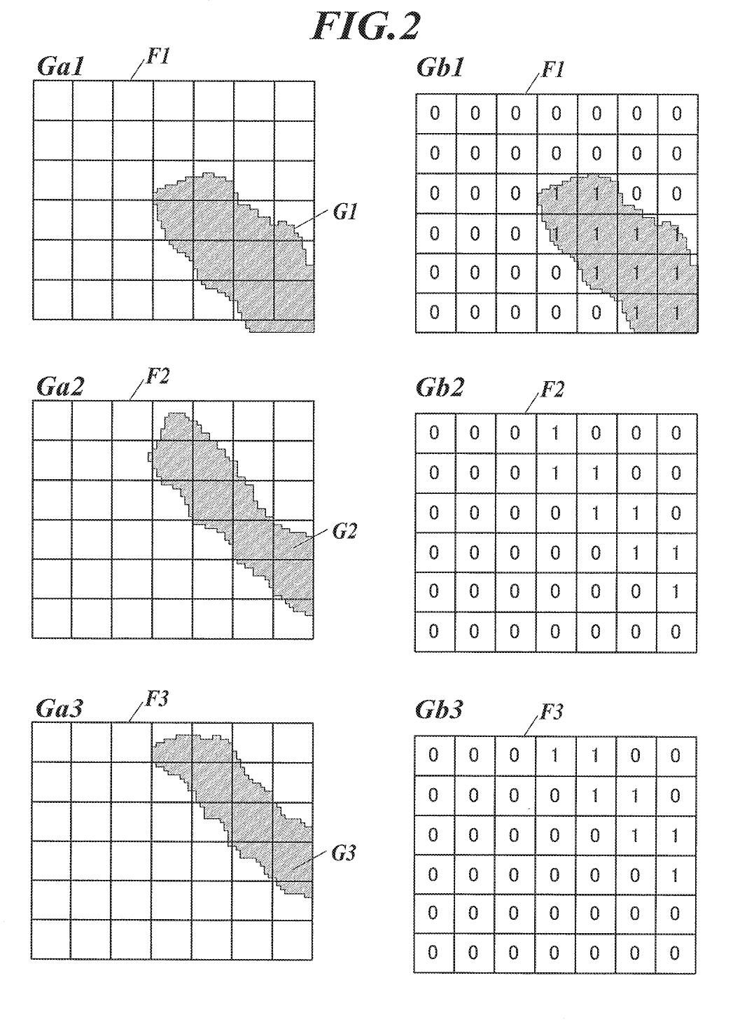

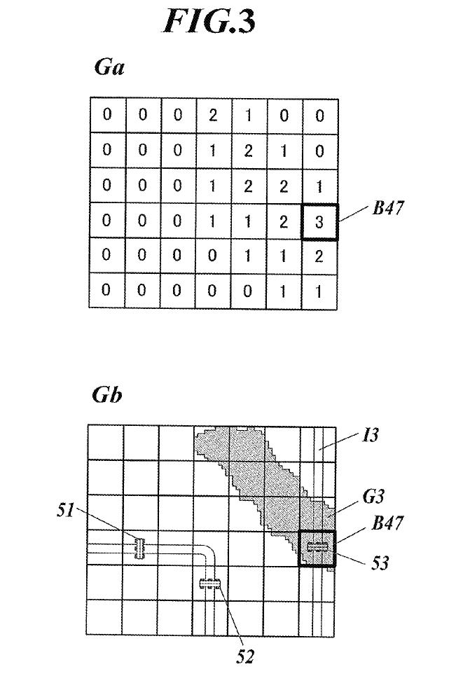

The steps of the processing described above will now be described in detail with reference to FIGS. 2 and 3. For simplification, the processing of three frames will be described.

The gas detector 31 detects a gas area G1 in a first frame F1, as illustrated in FIG. 2 Ga1.

In response, the block discriminator 33 assigns an identification value “1” to the blocks which are discriminated as the gas area, and an identification value “0” to the blocks which are not discriminated as the gas area, as illustrated in FIG. 2 Gb1.

The gas detector 31 then detects a gas area G2 in a second frame F2, as illustrated in FIG. 2 Ga2.

In response, the block discriminator 33 assigns an identification value “1” to the blocks which are discriminated as the gas area, and an identification value “0” to the blocks which are not discriminated as the gas area, as illustrated in FIG. 2 Gb2.

The gas detector 31 then detects a gas area G3 in a third frame F3, as illustrated in FIG. 2 Ga3.

In response, the block discriminator 33 assigns an identification value “1” to the blocks which are discriminated as the gas area, and an identification value “0” to the blocks which are not discriminated as the gas area, as illustrated in FIG. 2 Gb3.

The counted values of the respective blocks obtained by the counter 34 through the above process are illustrated in FIG. 3 Ga. With reference to FIG. 3 Ga, the leak location estimator 35 defines the block B47 having a counted value equal to or larger than a predetermined value as an estimated gas leak location. In this case, the predetermined value is the maximum value.

The image compositor 36 defines a visible light image I3 input from the visible light camera 20 as a back layer as illustrated in FIG. 3 Gb, extracts the pixels detected as the gas area by the gas detector 31 from the infrared image signal input from the infrared camera 10, converts the extracted pixels to a visible light range to obtain an infrared imaging visualization image (G3), overlays the infrared imaging visualization image (G3) on the back layer while setting a predetermined transmittance, and overlays an image indicating a block B47 set as the estimated gas leak location by the leak location estimator 35 thereon, to generate a composite image.

The composite image of the visible light image and the infrared imaging visualization image is displayed as a still image of the most recent frame among the frames used in the above processing or a moving image of several most recent frames.

### Second Embodiment

A gas leak location estimating system according to a second embodiment of the present invention will now be described.

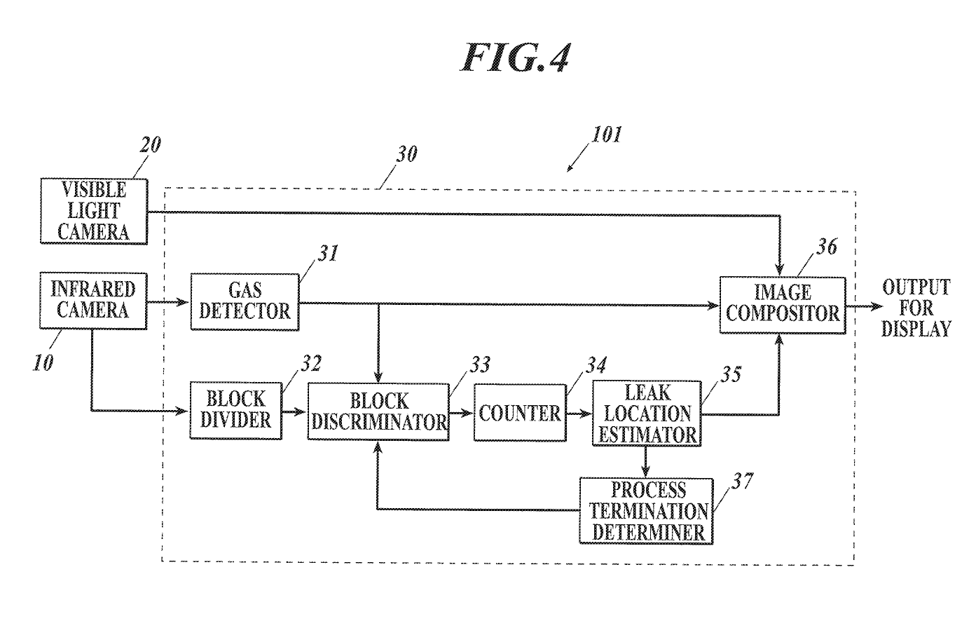

With reference to FIG. 4, the gas leak location estimating system 101 according to this embodiment is identical to the gas leak location estimating system 100 according to the first embodiment except that the information processor 30 further includes a process termination determiner 37.

The process termination determiner 37 determines whether the block set as the estimated gas leak location by the leak location estimator 35 remains unchanged over a predetermined number of times. For example, in the process described with reference to FIG. 2, the leak location estimator 35 executes the leak location estimation processing every three frames. In the case where the predetermined number of times is four, the process termination determiner 37 determines whether the block set as the estimated gas leak location by the leak location estimator 35 remains unchanged over four times.

If the block remains unchanged, the block discriminator 33 terminates the block discrimination processing. As a result, also the downstream steps by the counter 34, the leak location estimator 35, and the image compositor 36 are terminated.

The second embodiment described above can estimate a location of gas leak with certain reliability and reduce the load on the information processor 30.

### Third Embodiment

A gas leak location estimating system according to a third embodiment of the present invention will now be described.

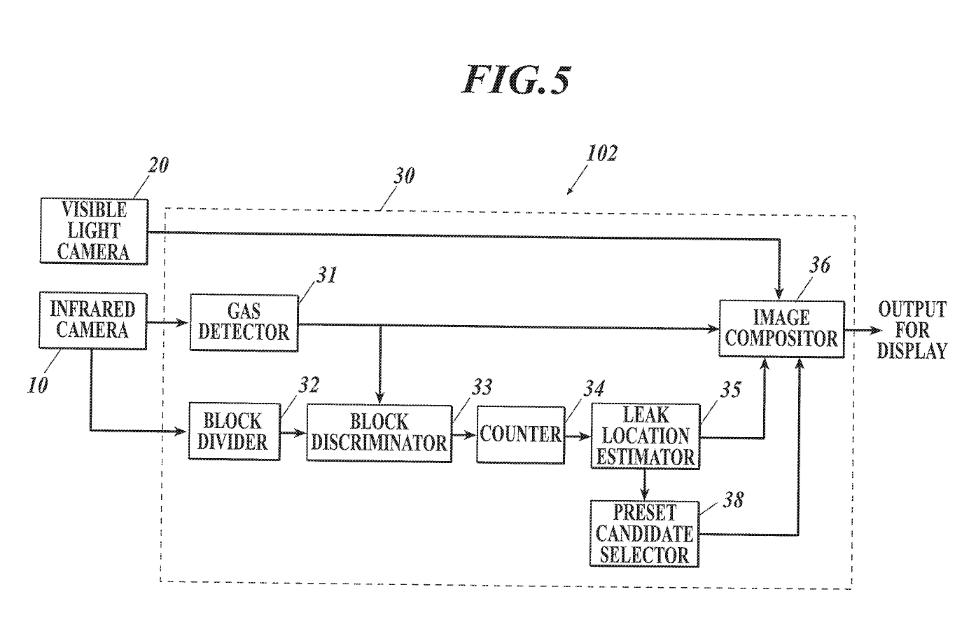

With reference to FIG. 5, the gas leak location estimating system 102 according to this embodiment is identical to the gas leak location estimating system 100 according to the first embodiment except that the information processor 30 further includes a preset candidate selector 38.

Multiple leak location candidates are preset by selection of positions in the frames captured by the infrared camera 10 and registered to the information processor 30.

The preset candidate selector 38 selects the leak location candidates closest to the block set by the leak location estimator 35.

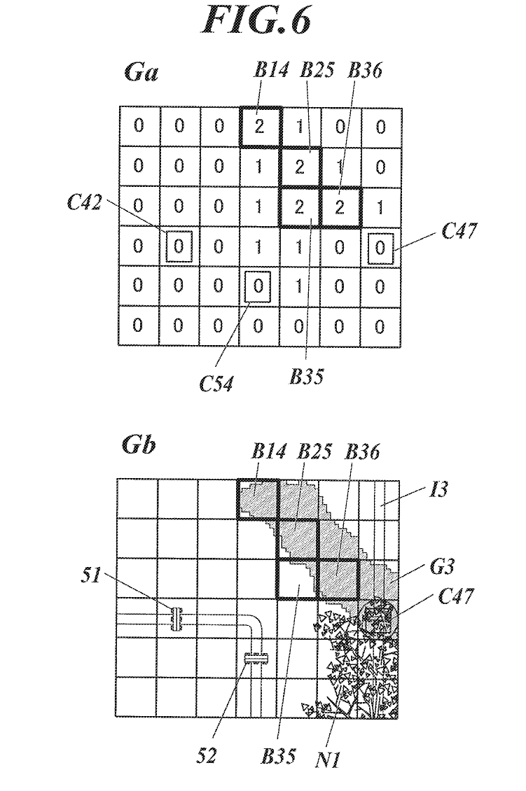

For example, blocks C42, C54, and C47 (see FIG. 6 Ga) depicting flanged joints 51, 52, and 53 are preliminarily set as the leak location candidates. This is because connections, such as joints, in the channel are prone to gas leakage.

The leak location estimator 35 estimates blocks B14, B25, B35, and B36 having maximum values “2” to be the locations of gas leak, as illustrated in FIG. 6 Ga.

The preset candidate selector 38 calculates the respective distances between the blocks B14, B25, B35 and B36 and the blocks C42, C47 and C54 and selects the leak location candidate having the smallest distance, i.e., the block C47. The distance should be the sum or average of linear distances calculated on the basis of the coordinates of the centers of the blocks.

With reference to FIG. 6 Gb, the image compositor 36 composes the image indicating the blocks B14, B25, B35 and B36 set by the leak location estimator 35 as in the first embodiment, and also composes the image indicating the block C47 selected by the preset candidate selector 38.

It should be noted that the image indicating the block C47 selected by the preset candidate selector 38 may be composed without composition of the image indicating the blocks B14, B25, B35 and B36 set by the leak location estimator 35.

According to the third embodiment described above, the gas leak location can be accurately estimated on the basis of preliminarily registered preset candidates, even if an obstacle N1, such as a tree, appears between the infrared camera 10 and the piping facility or monitoring target, as illustrated in FIG. 6 Gb. FIG. 3 Gb illustrates a case that the obstacle N1 does not exist in FIG. 6 Gb. In this case, the block set by the leak location estimator 35 matches the block selected by the preset candidate selector 38. When the blocks match in this way, it is preferred to display, in addition to the display of the matched blocks, the fact that the block set as the estimated gas leak location on the basis of the image processing matches the block selected as the preset gas leak candidate in a discriminable manner.

### Fourth Embodiment

A gas leak location estimating system according to a fourth embodiment of the present invention will now be described.

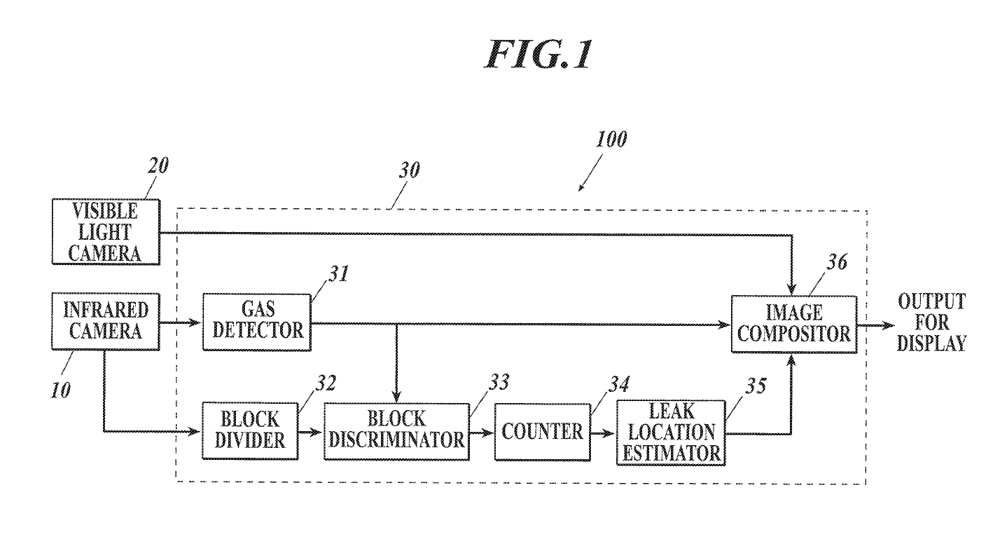

The gas leak location estimating system according to this embodiment has a configuration identical to that according to the first embodiment illustrated in FIG. 1 and executes the following process.

In this embodiment, the block divider 32 divides each frame image of an infrared image signal into 12×14 blocks.

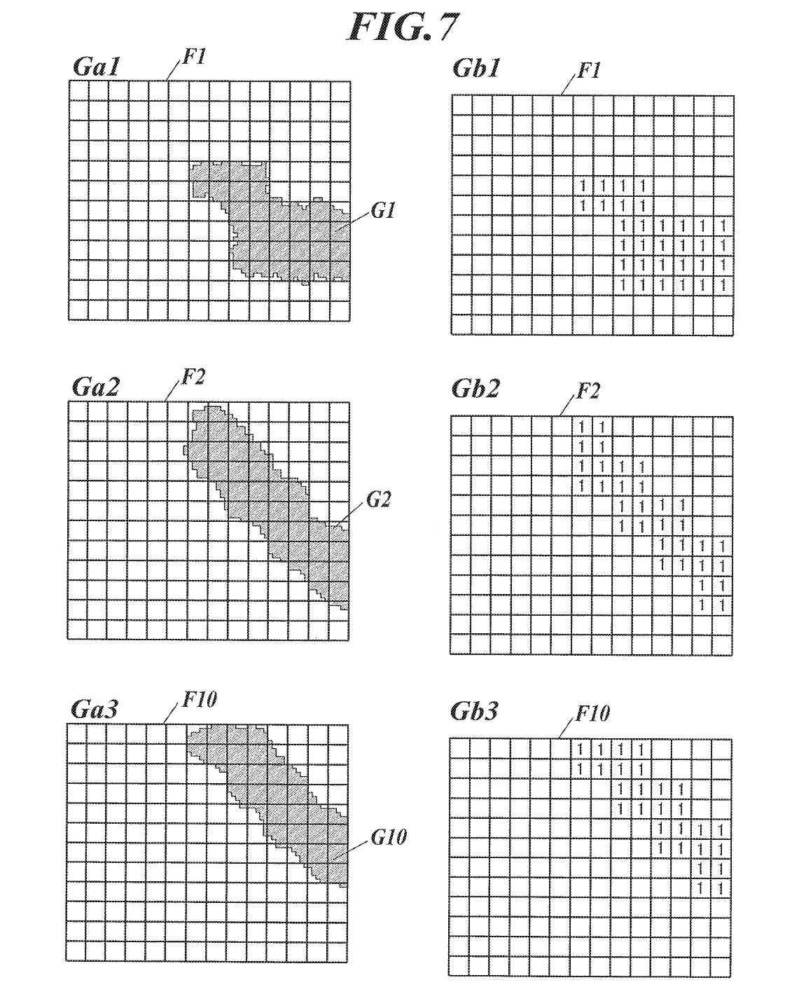

The gas detector 31 detects a gas area G1 in a first frame F1, as illustrated in FIG. 7 Ga1.

In response, the block discriminator 33 assigns an identification value “1” to the blocks which are discriminated as the gas area, and an identification value “0” to the blocks which are not discriminated as the gas area, as illustrated in FIG. 7 Gb1.

The gas detector 31 then detects a gas area G2 in a second frame F2, as illustrated in FIG. 7 Ga2.

In response, the block discriminator 33 assigns an identification value “1” to the blocks which are discriminated as the gas area, and an identification value “0” to the blocks which are not discriminated as the gas area, as illustrated in FIG. 7 Gb2.

Similarly, third to ninth frames are processed to assign an identification value “1” or “0” to every block in each frame.

The gas detector 31 then detects a gas area G10 in a tenth frame F10, as illustrated in FIG. 7 Ga3.

In response, the block discriminator 33 assigns an identification value “1” to the blocks which are discriminated as the gas area, and an identification value “0” to the blocks which are not discriminated as the gas area, as illustrated in FIG. 7 Gb3.

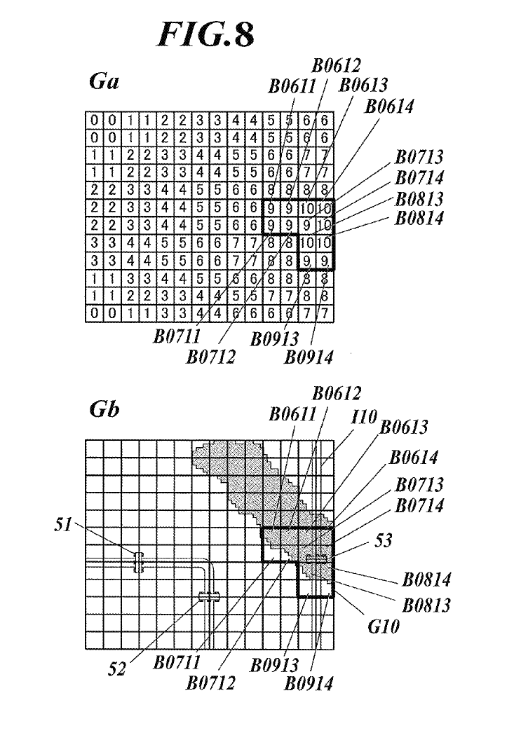

The counted values of the respective blocks obtained by the counter 34 through the above process are illustrated in FIG. 8 Ga. With reference to FIG. 8 Ga, the leak location estimator 35 discriminates the blocks B0611, B0612, B0613, B0614, B0711, B0712, B0713, B0714, B0813, B0814, B0913, and B0914 having counted values equal to or larger than a predetermined value as estimated locations of the gas leak. For example, the predetermined value is “9.”

The image compositor 36 defines a visible light image I10 input from the visible light camera 20 as a back layer as illustrated in FIG. 8 Gb, extracts the pixels detected as a gas area by the gas detector 31 from the infrared image signal input from the infrared camera 10, converting the extracted pixels to a visible light range to obtain an infrared imaging visualization image (G10), overlays the infrared imaging visualization image (G10) on the back layer while setting a predetermined transmittance, and overlays an image indicating the blocks B0611, B0612, B0613, B0614, B0711, B0712, B0713, B0714, B0813, B0814, B0913 and B0914 to be the estimated locations of the gas leak by the leak location estimator 35 thereon, to generate a composite image.

The composite image of the visible light image and the infrared imaging visualization image is displayed as a still image of the most recent frame among the frames used in the processing or a moving image of several most recent frames.

If a maximum value or a value smaller than the maximum value (the average, for example) is selected to be the threshold of the counted values for determining the estimated gas leak location, values exceeding the threshold are always included even if these values have low absolute values. This might hinder accurate estimation of the gas leak location.

According to the fourth embodiment described above, the threshold of the counted values for determining the estimated gas leak location is a constant value. Thus, the gas leak location is not estimated if the maximum value is smaller than this constant value. In this way, the gas leak location can be more accurately estimated without effects of noise and other factors.

In the embodiments described above, three or ten frames are processed to estimate the gas leak location. Any other number of frames may be appropriately selected in consideration of frame rate, calculation load, and estimated accuracy.

In the embodiments described above, the visible light image I3 captured by the visible light camera 20 is defined as the back layer, to emphasize the gas leak location estimated through image composition. Besides a captured image, the back layer may be a graphic image prepared in advance.

Although the embodiments described above include an image compositor 36, the image compositor 36 may be omitted because the composite image is displayed for the viewing of a user and unnecessary if the gas leak location estimated by the system according to the present invention is to be announced to another system including a computer.

Although embodiments of the present invention have been described and illustrated in detail, it is clearly understood that those are mere examples, and the scope of the present invention should not be limited to the examples in the descriptions and the appended claims.

### Industrial Applicability

The present invention can detect a gas leak, for example, in an industrial plant and specify the gas leak location.

### DESCRIPTION OF REFERENCE NUMERALS

10 infrared camera
20 visible light camera
30 information processor
F1 frame
F2 frame
F3 frame
G1 gas area
G2 gas area
G3 gas area
I3 visible light image
N1 obstacle

1. A gas leak location estimating device comprising:
an information processor which acquires image information on a plurality of frames from an infrared camera, the information processor being capable of executing:
a block discrimination processing of dividing an image area of each of the frames into a plurality of blocks and discriminating whether each of the blocks is a gas area;
a count processing of counting a number of times each of the blocks is discriminated as the gas area, over the frames in chronological order, in the block discrimination processing; and
a leak location estimation processing of setting, among the blocks, a block whose counted value obtained in the count processing is equal to or larger than a predetermined value as an estimated gas leak location.

2. The gas leak location estimating device of claim 1, wherein the information processor repeats the leak location estimation processing a predetermined number of times, and terminates the leak location estimation processing when the block set as the estimated gas leak location remains unchanged.

3. The gas leak location estimating device of claim 1, wherein the information processor is capable of further executing:
a preset candidate selection processing of referring to a plurality of leak location candidates set in advance by specifying one or more positions in each of the frames, and selecting, among the leak location candidates, a leak location candidate closest to the block set in the leak position estimation processing.

4. A gas leak location estimating system comprising:
the gas leak location estimating device of claim 1; and
an infrared camera which has an imaging range containing a monitoring target and sends the image information to the information processor.

5. A gas leak location estimating method acquiring image information on a plurality of frames from an infrared camera, the method comprising:
a block discrimination processing of dividing an image area of each of the frames into a plurality of blocks and discriminating whether each of the blocks is a gas area;
a count processing of counting a number of times each of the blocks is discriminated as the gas area, over the frames in chronological order, in the block discrimination processing; and
a leak location estimation processing of setting, among the blocks, a block whose counted value obtained in the count processing is equal to or larger than a predetermined value as an estimated gas leak location.

6. The gas leak location estimating method of claim 5, wherein the leak location estimation processing is repeated a predetermined number of times, and the leak location estimation processing is terminated when the block set as the estimated gas leak location remains unchanged.

7. The gas leak location estimating method of claim 5, further comprising:
a preset candidate selection processing of referring to a plurality of leak location candidates set in advance by specifying one or more positions in each of the frames, and selecting, among the leak location candidates, a leak location candidate closest to the block set in the leak position estimation processing.

8. A non-transitory recording medium storing a computer readable program causing a computer which acquires image information on a plurality of frames from an infrared camera, to execute:
a block discrimination processing of dividing an image area of each of the frames into a plurality of blocks and discriminating whether each of the blocks is a gas area;
a count processing of counting a number of times each of the blocks is discriminated as the gas area, over the frames in chronological order, in the block discrimination processing; and
a leak location estimation processing of setting, among the blocks, a block whose counted value obtained in the count processing is equal to or larger than a predetermined value as an estimated gas leak location.

9. The non-transitory recording medium of claim 8 causing the computer to further execute:
a process of repeating the leak location estimation processing a predetermined number of times and terminating the leak location estimation processing when the block set as the estimated gas leak location remains unchanged.

10. The non-transitory recording medium of claim 8 causing the computer to further execute:
a preset candidate selection processing of referring to a plurality of leak location candidates set in advance by specifying one or more positions in each of the frames, and selecting, among the leak location candidates, a leak location candidate closest to the block set in the leak position estimation processing.
